(19) United States
(12) Patent Application Publication
(10) Pub. No.: US 2015/0161743 A1
(43) Pub. Date: Jun. 11, 2015

(54) SYSTEM AND METHOD FOR AUTOMATICALLY CLASSIFYING TRANSACTION INFORMATION

(71) Applicant: MasterCard International Incorporated, Purchase, NY (US)

(72) Inventors: Kenny Unser, Fairfield, CT (US); Serge Bernard, Danbury, CT (US); Nikhil Malgatti, Stamford, CT (US)

(73) Assignee: MasterCard International Incorporated, Purchase, NY (US)

(21) Appl. No.: 14/098,934

(22) Filed: Dec. 6, 2013

(51) Int. Cl. G06Q 40/00

(52) U.S. Cl. CPC G06Q 40/12

(57) ABSTRACT

According to some embodiments, transaction information associated with payments made via a payment account may be retrieved from a transaction database. A code book may be accessed containing a plurality of payment codes and, for each payment code, logic defining when that payment code is applicable to a payment. The retrieved transaction information may then be analyzed to automatically determine which payment codes are associated with each payment. The automatically determined coded transaction information may then be output.

### BACKGROUND

Different types of information about a person may be of interest to various entities. For example, an advertising company might want to know if a person is currently a college student to determine products and/or services that might be of interest to that particular person. Similarly, a sports equipment manufacturer might be interested in determining which people in a particular region lead active lifestyles (e.g., by hiking, playing sports, etc.). Attempting to manually determine this type of information for a group of people, such as by conducting a telephone or online survey, can be an expensive, time-consuming, and error prone task, especially when a substantial number of people are involved. As a result, systems and methods to automatically determine information about people may be desired.

### BRIEF DESCRIPTION OF THE DRAWINGS

FIG. 1 is a block diagram overview of a system according to some embodiments of the present invention.

FIG. 2 illustrates a method that might be performed in accordance with some embodiments.

FIG. 3 is block diagram of an classification tool or platform according to some embodiments of the present invention.

FIG. 4 is a tabular portion of a transaction database according to some embodiments.

FIG. 5 is a tabular portion of a code book in accordance with some embodiments described herein.

FIG. 6 is a tabular portion of coded transaction database according to some embodiments.

FIG. 7 illustrates a method that might be performed in accordance with some embodiments.

FIG. 8 is an example of a display that might be provided in accordance with some embodiments.

FIG. 9 is a block diagram of a system including a predictive model generator according to some embodiments.

FIG. 10 is a flow chart illustrating how a predictive model might be generated according to some embodiments.

### DETAILED DESCRIPTION

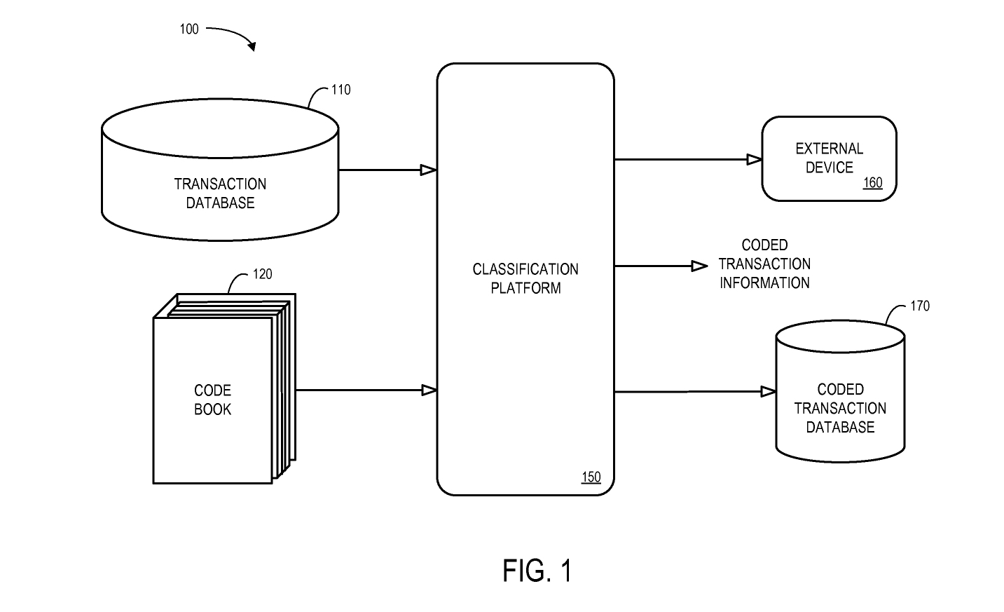

Information about a person or entity may be of interest to various parties. For example, an insurance or advertising company might want to know if a person lives an usually active lifestyle. Similarly, a person's occupation or hobbies may be of interest. For example, a marketing firm might be interested in determining which people in a particular region regularly drive to work. Attempting to manually determine this type of information for a group of people, such as by conducting a telephone or online survey, can be an expensive, time-consuming, and error prone task, especially when a substantial number of people are involved. It would therefore be desirable to provide accurate and efficient systems and methods to automatically determine information about people. FIG. 1 is block diagram of a system 100 according to some embodiments of the present invention. In particular, the system 100 includes a classification platform 150 that receives information from a transaction database 110 and a code book 120 and outputs coded transaction information, such as by outputting the coded transaction information to an external device 160 and/or a coded transaction information database 170.

The classification platform 150 might be, for example, associated with a Personal Computer (PC), laptop computer, an enterprise server, a server farm, and/or a database or similar storage devices. The classification platform 150 may, according to some embodiments, be associated with a credit card company.

According to some embodiments, an “automated” classification platform 150 may facilitate the determination of coded transaction information. For example, the classification platform 150 may automatically output a list of people who east fast food relatively infrequently. As used herein, the term “automated” may refer to, for example, actions that can be performed with little (or no) intervention by a human.

As used herein, devices, including those associated with the classification platform 150 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The classification platform 150 may retrieve transaction information from the transaction database 110. The transaction database 110 might be associated with, for example, payment accounts, such as credit card or bank accounts. The transaction database 110 may be locally stored or reside remote from the classification platform 150. As will be described further below, the transaction database 110 and code book 120 may be used by the classification platform 150 to generate coded transaction information. According to some embodiments, the classification platform 150 communicates coded transaction information to an external device 160, such as by transmitting an electronic file to an email server, a workflow management system, etc. In other embodiments, the classification platform 150 might store coded transaction information in a coded transaction information database 170.

Although a single classification platform 150 is shown in FIG. 1, any number of such devices may be included. Moreover, various devices described herein might be combined according to embodiments of the present invention. For example, in some embodiments, the classification platform 150, transaction database 110, and/or code book 120 might be co-located and/or may comprise a single apparatus.

In accordance with some embodiments, the systems and methods described herein provide a framework to determine coded transaction information based on transaction information associated with payment accounts. For example, a payment card may presented by a cardholder (e.g., the account owner) to make a payment. By way of example, and without limiting the generality of the foregoing, a payment card can be a credit card, debit card, charge card, stored-value card, or prepaid card or nearly any other type of financial transaction card. Further, as used herein in, the term “issuer” or “attribute provider” can include, for example, a financial institution (i.e., bank) issuing a card, a merchant issuing a merchant specific card, a stand-in processor configured to act on-behalf of the card-issuer, or any other suitable institution configured to issue a payment card. As used herein, the term “transaction” can be associated with, for example, a merchant, a merchant terminal, an automated teller machine (ATM), or any other suitable institution or device configured to initiate a financial transaction per the request of the account owner.

The information in the transaction database 110 may be associated with, for example, a “payment card processing system” or “credit card processing networks”, such as the MasterCard® network that allows account owners to use payment cards issued by a variety of issuers to shop at a variety of merchants. With this type of payment card, a card issuer or attribute provider, such as a bank, extends credit to an account owner to purchase products or services. When an account owner makes a purchase from an approved merchant, the card number and amount of the purchase, along with other relevant information, are transmitted via the processing network to a processing center, which verifies that the card has not been reported lost or stolen and that the card's credit limit has not been exceeded. In some cases, the account owner's signature is also verified, a personal identification number is required or other user authentication mechanisms are imposed. The account owner is required to repay the bank for the purchases, generally on a monthly basis.

The transaction database 110 may further store a “business classification,” which is a group of merchants and/or businesses, by the type of goods and/or service the merchant and/or business provides. For example, the group of merchants and/or businesses can include merchants and/or business, which provide similar goods and/or services. In addition, the merchants and/or businesses can be classified based on geographical location, sales, and any other type of classification, which can be used to associate a merchant and/or business with similar goods, services, locations, economic and/or business sector, industry and/or industry group.

The transaction database 110 may also store a “merchant category code” or “MCC,” which is a four-digit number created by MasterCard® or VISA® and assigned to a business by the acquirer when the business first starts accepting one of these cards as a form of payment. The MCC is used to classify the business by the type of goods or services it provides. For example, in the United States, the merchant category code can be used to determine if a payment needs to be reported to the IRS for tax purposes. In addition, Merchant Category Codes (or “MCCs”) are used by card issuers to categorize, track or restrict certain types of purchases.

In accordance with some embodiments, data associated with payment card transactions is stored within the transaction database 110. The data may include, for example, a listing of sales amount for each payment card transaction including the type of goods and/or services sold, a total number of goods and/or services sold in each transaction, a total sales amount for each transaction (e.g., gross dollar amount). In addition, for each merchant and/or business, the data associated with each transaction may include a point-of-sale or point-of-purchase (e.g., location of each payment card transaction). The point-of-sale or point-of-purchase provides that for merchants and/or businesses having one or more locations, the location of the merchant and/or business, which generated the sale can be identified.

The code book 120 may include logic, rules, and/or algorithms that may be applied to the transaction database 110. The code book 120 might be associated with an industry standard similar to those associated with the Conflict And Mediation Event Observations (“CAMEO”) standard associated with unstructured communications or the North American Industry Classification System (“NAICS”) standard used by Federal statistical agencies to classify business establishments for the purpose of collecting, analyzing, and publishing statistical data related to the U.S. business economy.

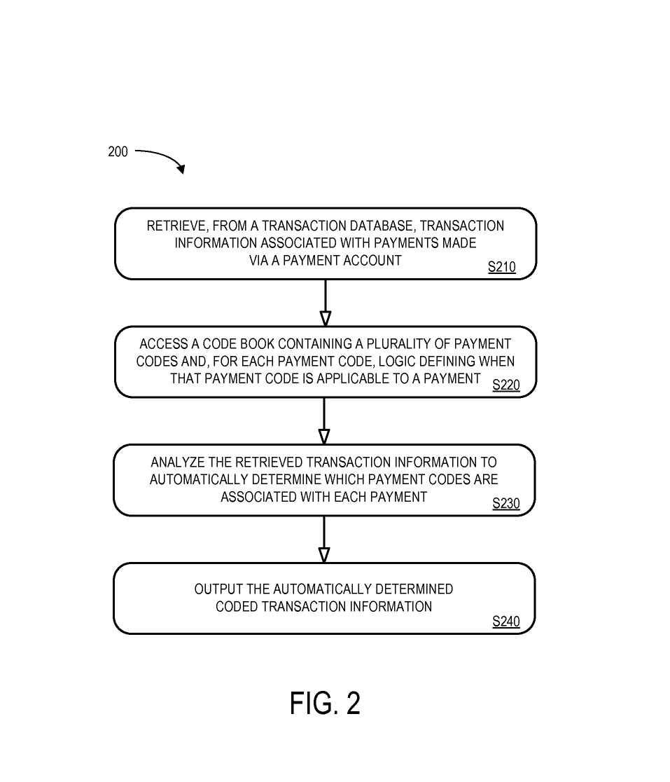

FIG. 2 illustrates a method that might be performed by some or all of the elements of the system 100 described with respect to FIG. 1 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, transaction information associated with payments made via a payment account (e.g., associated with an account owner) may be retrieved from a transaction database. The payment account may be associated, for example, a credit card account, a debit card account, a bank account, a pre-paid card account, or any other type of payment account. The transaction information may include, for example, an account identifier, a merchant identifier, a date, a time of day, a payment amount, a payment description, or any other type of transaction information. Note that the payment account might be associated a single consumer, a household, a business making purchases via the payment account, and/or a merchant receiving payments via the payment account.

At S220, a code book may be accessed. The code book may contain, for example, a plurality of payment codes and, for each payment code, logic defining when that payment code is applicable to a payment. At S230, the retrieved transaction information may be analyzed to automatically determine which payment codes are associated with each payment. The automatically determined coded transaction information may then be output at S240.

The payment codes in the code book may enhance the value of transaction data by assigning attributes that make the data more meaningful. For example, transactions described as “weekday child care” or “late weeknight pizza purchase” may be more indicative of the type of cardholder than knowing the typical transaction details (e.g., amount, date, time, merchant name). The use of a code book may enhance transactions information so as to make the data more useful to analysts seeking to create or match a profile of the person making those transactions.

By way of example only, at least one of the payment codes might be associated with a “time category.” The time category codes might, for example, be associated with at least one of: a weekday indication, a weekend indication, a school year indication, a business hours indication, a holiday indication, an early morning indication, and/or a late night indication.

As another example, at least one of the payment codes might be associated with a “geography category.” The geography category codes might, for example, be associated with at least one of: a college town indication, an urban indication, a suburban indication, a rural indication, a travel indication, an industrial indication, and/or a residential indication.

As still another example, at least one of the payment codes might be associated with a “spend category.” The spend category codes might, for example, be associated with at least one of: an essential spend indication, a healthy spend indication, a sedentary spend indication, a high-end or luxury spend indication, and/or a do-it-yourself spend indication.

As yet another example, at least one of the payment codes might be associated with a “behavior category.” The behavior category codes might, for example, be associated with at least one of: a repetitive purchase indication, a one-time purchase indication, a high-spend indication, and/or a purchase sequencing indication.

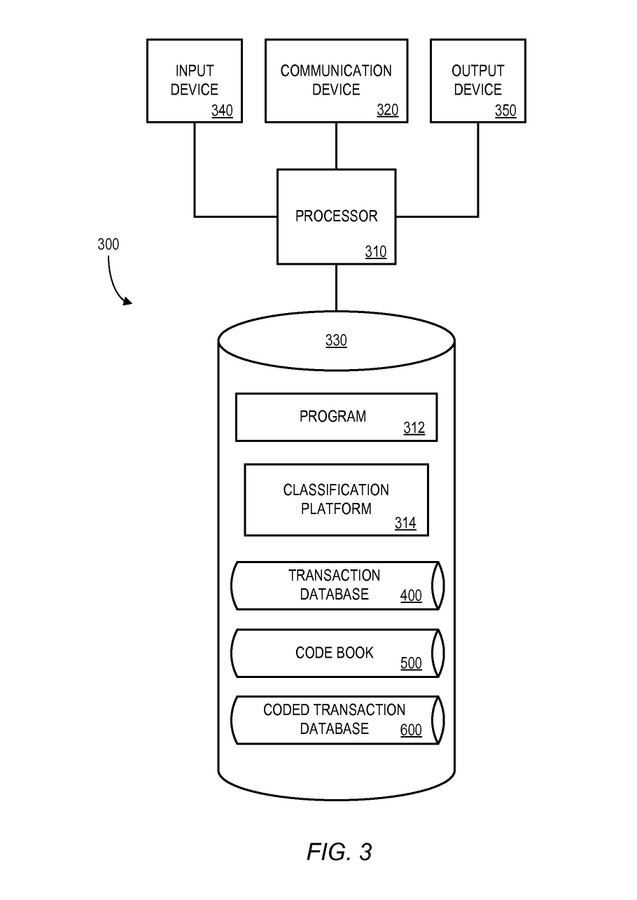

In this way, transaction information may be analyzed to automatically determine coded transaction information. Note that the embodiments described herein may be implemented using any number of different hardware configurations. For example, FIG. 3 illustrates a classification platform 300 that may be, for example, associated with the system 100 of FIG. 1. The classification platform 300 comprises a processor 310, such as one or more commercially available Central Processing Units (CPUs) in the form of one-chip microprocessors, coupled to a communication device 320 configured to communicate via a communication network (not shown in FIG. 3). The communication device 320 may be used to communicate, for example, with one or more transaction databases. The classification platform 300 further includes an input device 340 (e.g., a computer mouse and/or keyboard to enter information about codes) and an output device 350 (e.g., a computer monitor or printer to output a coded transaction information report).

The processor 310 also communicates with a storage device 330. The storage device 330 may comprise any appropriate information storage device, including combinations of magnetic storage devices (e.g., a hard disk drive), optical storage devices, mobile telephones, and/or semiconductor memory devices. The storage device 330 stores a program 312 and/or analyzer platform logic 314 for controlling the processor 310. The processor 310 performs instructions of the programs 312, 314, and thereby operates in accordance with any of the embodiments described herein. For example, the processor 310 may retrieve transaction information associated with payments made via a payment account (e.g., a credit card account associated with an account owner) from a transaction database. The retrieved transaction information may then be analyzed by the processor 310 to automatically determine coded transaction information associated with the account or account owner. For example, codes associated with the owner's occupation or hobbies might be automatically determined by the processor 310.

The programs 312, 314 may be stored in a compressed, uncompiled and/or encrypted format. The programs 312, 314 may furthermore include other program elements, such as an operating system, a database management system, and/or device drivers used by the processor 310 to interface with peripheral devices.

As used herein, information may be “received” by or “transmitted” to, for example: (i) the classification platform 300 from another device; or (ii) a software application or module within the classification platform 300 from another software application, module, or any other source.

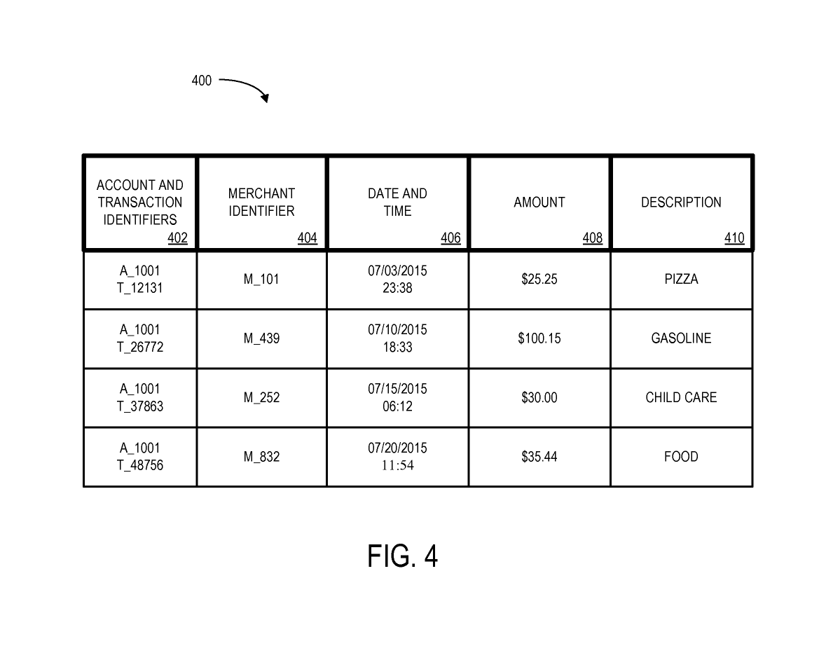

In some embodiments (such as shown in FIG. 3), the storage device 330 further stores a transaction database 400, a code book 500, and a coded transaction database 600. Some examples of databases that may be used in connection with the classification platform 300 will now be described in detail with respect to FIGS. 4 through 6. Note that the databases described herein are only examples, and additional and/or different information may actually be stored therein. Moreover, various databases might be split or combined in accordance with any of the embodiments described herein. For example, the transaction database 400 and coded transaction database 600 might be combined and/or linked to each other within the classification platform 300.

Referring to FIG. 4, a table is shown that represents the transaction database 400 that may be stored at the classification platform 300 according to some embodiments. The table may include, for example, entries identifying transactions that have been processed via a payment account (e.g., credit card transactions). The table may also define fields 402, 404, 406, 408, 410 for each of the entries. The fields 402, 404, 406, 408, 410 may, according to some embodiments, specify: account and transaction identifiers 402, a merchant identifier 404, a date and time 406, an amount 408, and a description 410. The transaction database 400 may be created and updated, for example, based on information electrically received on a periodic basis.

The account identifier 402 may be, for example, a unique alphanumeric code identifying a payment account, such as a Primary Account Number (“PAN”). The transaction identifier 402 may be associated with a particular transaction (e.g., a purchase at a gas station). The date and time 406 may indicate when the transaction occurred, and the amount 408 may indicate the monetary amount of the transaction. The description may indicate what was purchased in the transaction (e.g., a general indication that a credit card was used at a gasoline pump, a type of goods or services typically offered by the merchant, etc.).

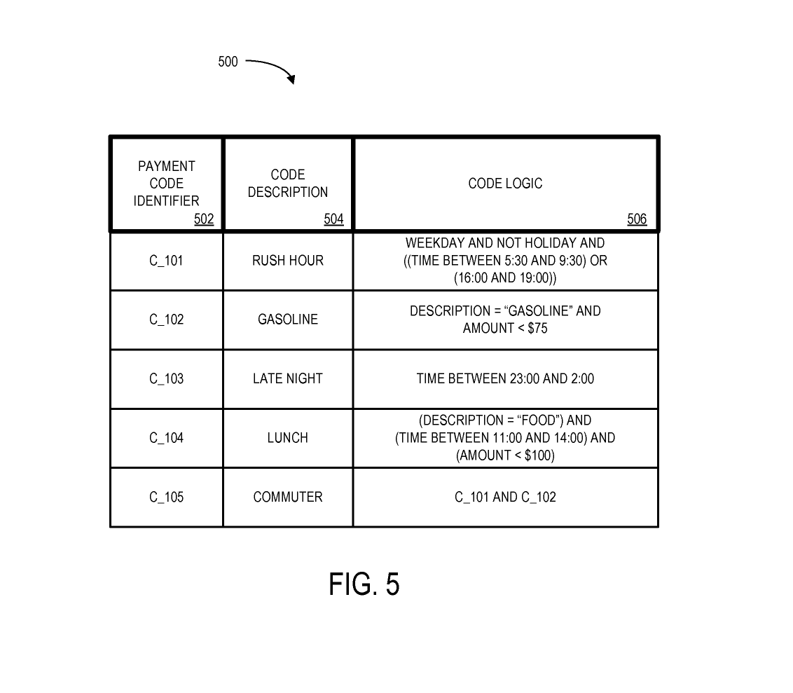

Referring to FIG. 5, a table is shown that represents the code book 500 that may be stored at the classification platform 300 according to some embodiments. The table may include, for example, entries identifying merchants involved in the transactions. The table may also define fields 502, 504, 506 for each of the entries. The fields 502, 504, 506 may, according to some embodiments, specify: a payment code identifier 502, a code description 504, and code logic 506. The code book 500 may be created and updated, for example, based on information created by an analyst or predictive model.

The payment code identifier 502 may be, for example, a unique alphanumeric code identifying a code, the code description 504 may describe the code, and the code logic 506 may define when the code should be associated with a particular transaction. By way of example, payment code identifier 502 “C_{—}104” may indicate that a transaction is associated with an account owner purchasing his or her lunch. Here, the code logic 506 indicates that code “C_{—}104” is applicable to transactions having a description 410 of “FOOD” that were made between 11:00 and 14:00 having a transaction amount of less than $100.00. Note that a “compound code” may be based on the presence of one or more other codes. For example, code “C_{—}105” is applicable to transactions that have both codes “C_{—}101” and “C_{—}102.” That is, gasoline purchases that occur during rush hour might be associated with commuters who drive to work. Note that an actual code book 500 might store tens of thousands of such codes.

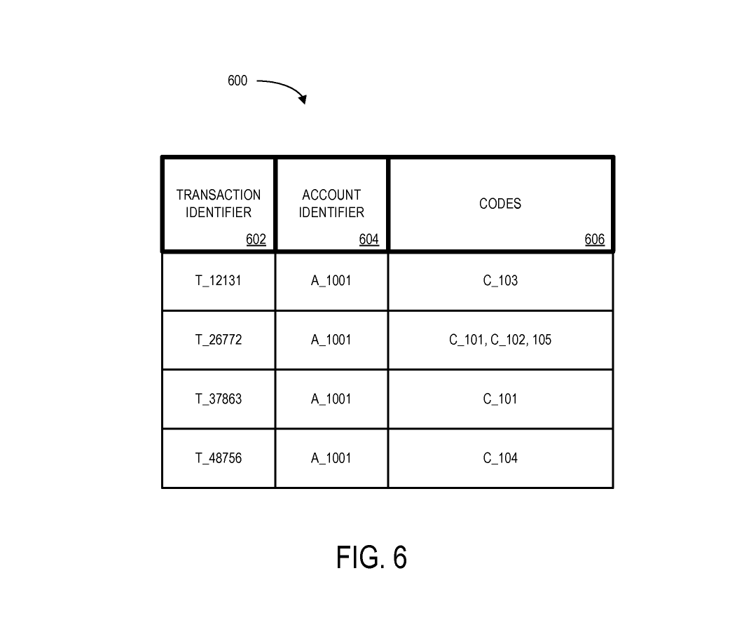

Referring to FIG. 6, a table is shown that represents the coded transaction database 600 that may be stored at the classification platform 300 according to some embodiments. The table may include, for example, entries identifying payment accounts associated with the transactions. The table may also define fields 602, 604, 606 for each of the entries. The fields 602, 604, 606 may, according to some embodiments, specify: a transaction identifier 602, an account identifier 604, and one or more codes 606. The transaction database 600 may be created and updated, for example, automatically by a classification platform based on transaction data and a code book.

The transaction identifier 602 and the account identifier 602 may be, for example, unique alphanumeric codes identifying a particular purchase and a payment account and may, or may not, be associated with the account and transaction identifiers 402 in the transaction database 400. The codes 606 indicate which codes from the code book 500 apply to each transaction. For example, code “C_{—}103” (“LATE NIGHT”) is applicable to transaction “T_{—}12131” because it occurred between 23:00 and 2:00.

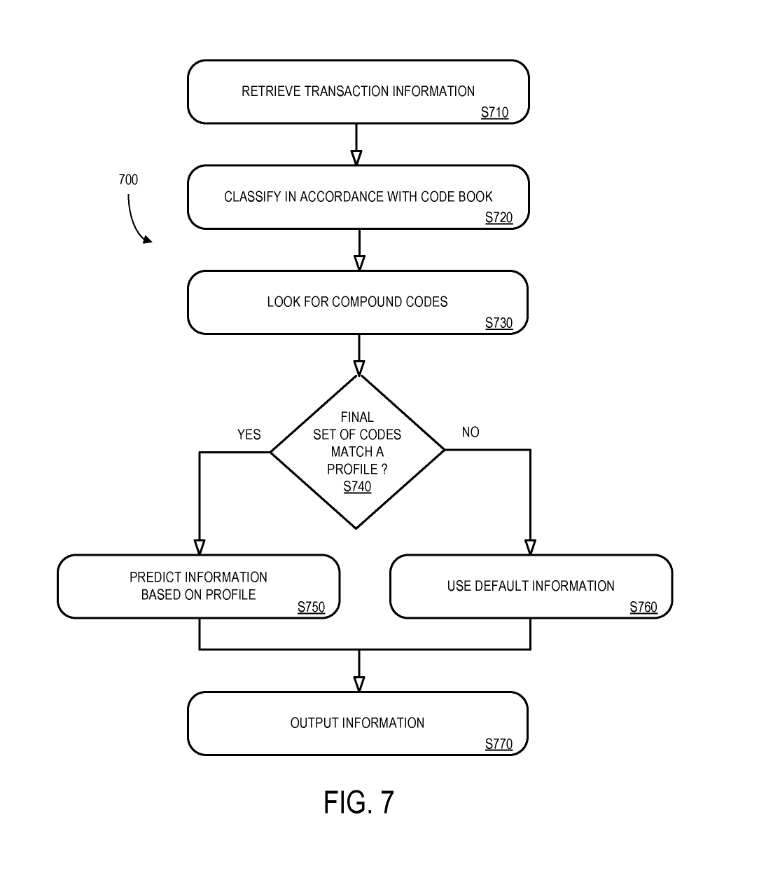

FIG. 7 illustrates a method that might be performed in accordance with some embodiments. At S710, transaction information may be retrieved, and the data may be classified in accordance with one or more code books at S720. After an initial assignment of codes, the system may look to determine if any compound codes are applicable. If the final set of codes match a profile at S740, information about the person making the purchases (or the business receiving payments) may be predicted based on the profile at S740. For example, if a payment account owner makes frequent purchases at sport goods stores during the winter, he or she might match a “skier” profile. If there is no match at S740, the default information may be used at S760. In either case, the information may be output, such as in a report or display, at S770.

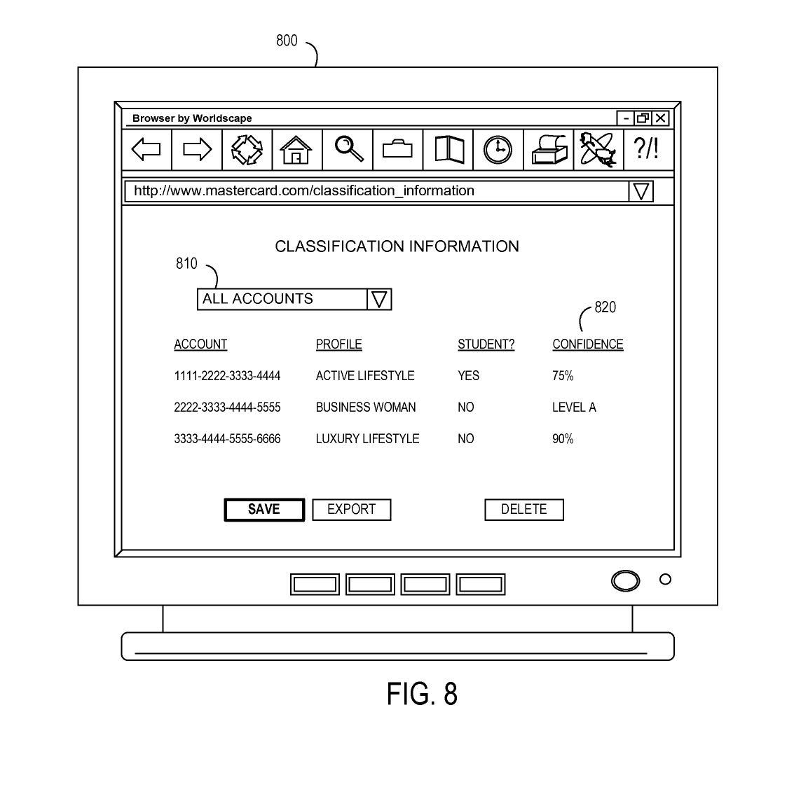

FIG. 8 is an example of a display 800 that might be provided in accordance with some embodiments. In particular, a user might select 810 which type of coded transaction information should be included on the display (e.g., all payment account owners who are residents of California, all account owners who are under 35 years old, etc.). Moreover, as illustrated in FIG. 8, a classification platform may generate and display a “confidence level” associated with the coded transaction information. The confidence level might indicate, for example, how likely it is that estimated or predicted coded transaction information is actually correct (e.g., by a percentage likelihood or a confidence category).

Note that rules and logic described with respect to FIGS. 2 and 7 might be manually designed and constructed by a human operator. For example, an analyst might design logic or rules for the assignment of transactions to categories and assign coded values to each category. By way of example only, the analyst might assign the following codes in a code book:
Code 1234=Weekday
Code 2345=Commercial Area
Code 3456=Child Care Business
Code 4567=Repeat Customer
Code 5678=High End

The assigned codes might be documented and appropriate logic may be defined for each code. The codes may then be applied to transaction data in connection with analysis projects to evaluate the usefulness of the codes. Feedback may be collected feedback from customers and/or pilot users who may suggest additions and/or revisions of the code book. When sufficiently useful, revisions of the code book might be periodically released.

Consider, for example, a first cardholder profile having the following un-coded purchase history:

1. Purchase at Luigi's Restaurant on September 5 for $3.00 at 12:30 am;

2. Purchase at ABC of Ithaca, N.Y. on September 6 for $12.50 as 11:00 am; and

3. Purchase at Wolverines Bookstore for $525 on September 7 at 2:00 pm.

After application of the example codes previously described, as well as other codes, the coded transaction information might comprise (and a potential “college student” profile might be matched):

1. Late night (Code 1234) pizza purchase (Code 2345) on a weeknight (Code 1235) for a small amount (Code 5678);

2. Day time (Code 1236) alcohol purchase (Code 2346) in a college town (Code 6543); and

3. Bookstore purchase (Code 3456) for a high amount (Code 5679) during school year (Code 4321).

Consider, now a second cardholder profile having the following un-coded purchase history:

1. Purchase at Mobil Gas Station for $60 on September 5 at 8:30 am;

2. Purchase at Off Your Hands Nursery for $120 on September 6 at 5:20 pm; and

3. Purchase at Quick Eats Food Cart of Lower Manhattan on September 7 at 12:15 pm.

After application of the example codes previously described, as well as other codes, the coded transaction information might comprise (and a potential “working parent” profile might be matched):

1. Rush hour (code 0987) gas purchase (code 9876);

2. Weekday (code 2332) child care services (code 8765); and

3. Lunchtime (code 4354) small amount (code 5678) food purchase (code 5445) in a commercial area (code 7777).

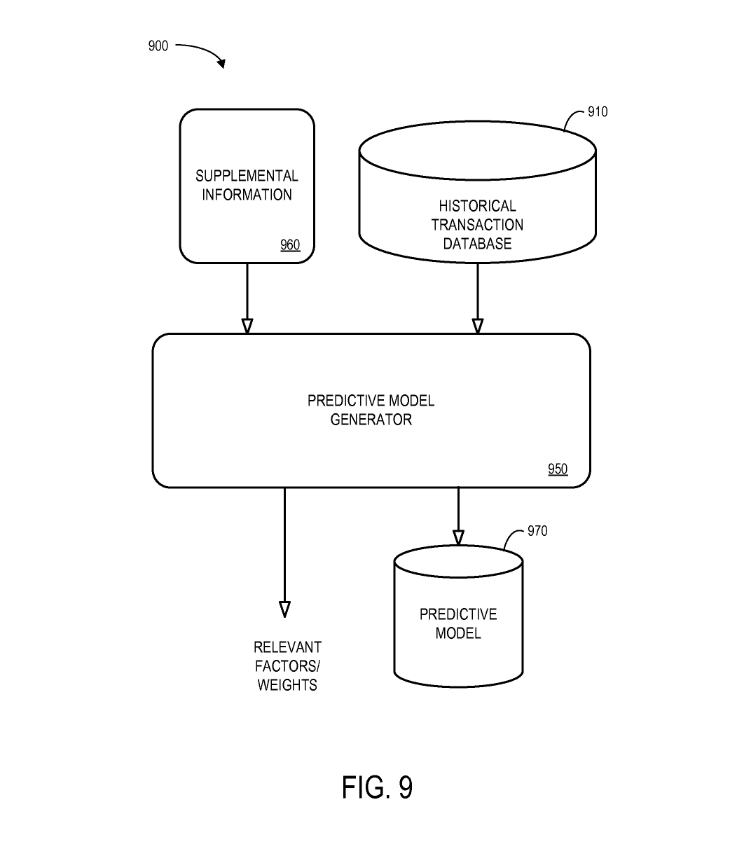

Thus, human-defined logic may be used to identify relevant factors to enhance and enrich payment transaction information (e.g., by realizing the college students frequently spend a relative large amount of money on books at the beginning of a school year). In some cases, however, relevant factors in a transaction database may be automatically identified and/or used to create a predictive model. For example, FIG. 9 is a block diagram of a system 900 including a predictive model generator 950 according to some embodiments. The predictive model generator 950 may receive supplemental information 960 along with historical transaction database 910 information. For example, historical credit card purchases may be received along with a list indicating which of those account owners regularly drive to work (e.g., from a survey or insurance database).

The predictive model generator 950 may look for patterns in the historical transaction information to identify relevant factors and/or associated weights. For example, account owners who have transactions with a sporting goods store might be identified as being highly likely to live an active lifestyle.

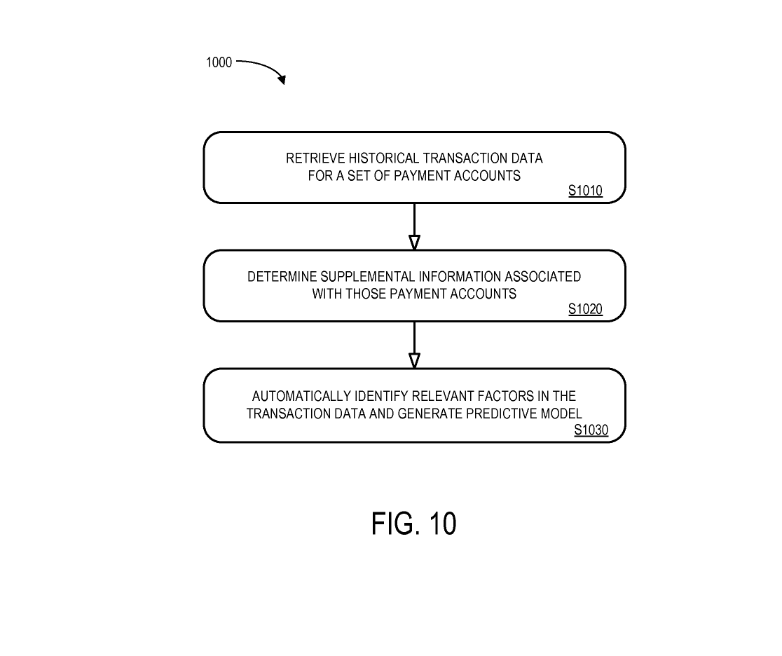

FIG. 10 is a flow chart illustrating how a predictive model might be generated according to some embodiments. At S1010, historical transaction data is retrieved from a set of payment accounts. Supplemental information associated with those payment accounts is determined at S1020. The relevant factors in the historical transaction data may be automatically identified at S1030 and a predictive model may be automatically generated.

Thus, according to some embodiments, coded transaction information may be based at least in part on rules created by a predictive model trained with historical transaction information. According to some embodiments, a predictive model utilizes different groupings associated with different sets and/or weights of relevant factors. For example, depending on high level grouping, different variables may be significant and/or relevant and the weightings of common variables may be different.

In general, and for the purposes of introducing concepts of embodiments of the present invention, a computer system may incorporate a “predictive model.” As used herein, the phrase “predictive model” might refer to, for example, any of a class of algorithms that are used to understand relative factors contributing to an outcome, estimate unknown outcomes, discover trends, and/or make other estimations based on a data set of factors collected across prior trials. Note that a predictive model might refer to, but is not limited to, methods such as ordinary least squares regression, logistic regression, decision trees, neural networks, generalized linear models, and/or Bayesian models. The predictive model is trained with historical transaction information, and may be applied to current or test transactions to determine code book codes and/or coded transaction information.

The predictive model generator 950 may operate generally in accordance with conventional principles for predictive models, except, as noted herein, for at least some of the types of data to which the predictive model component is applied. Those who are skilled in the art are generally familiar with programming of predictive models. It is within the abilities of those who are skilled in the art, if guided by the teachings of this disclosure, to program a predictive model to operate as described herein. The predictive model generator 950, in various implementation, may include one or more of neural networks, Bayesian networks (such as Hidden Markov models), expert systems, decision trees, collections of decision trees, support vector machines, or other systems known in the art for addressing problems with large numbers of variables. According to some embodiments, the predictive model(s) are trained on prior data and supplemental information known to a credit card company. The specific data and outcomes analyzed may vary depending on the desired functionality of the particular predictive model. The particular data parameters selected for analysis in the training process may be determined by using regression analysis and/or other statistical techniques known in the art for identifying relevant variables in multivariable systems.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method, comprising:
retrieving, from a transaction database, transaction information associated with payments made via a payment account;
accessing a code book containing a plurality of payment codes and, for each payment code, logic defining when that payment code is applicable to a payment;
analyzing, by a computer processor of a classification platform, the retrieved transaction information to automatically determine which payment codes are associated with each payment; and
outputting the automatically determined coded transaction information.

2. The method of claim 1, wherein the payment account is associated with at least one of: (i) a credit card account, (ii) a debit card account, (iii) a bank account, and (iv) a pre-paid card account.

3. The method of claim 1, wherein the transaction information comprises at least one of: (i) an account identifier, (ii) a merchant identifier, (iii) a date, (iv) a time of day, (v) a payment amount, and (vi) a payment description.

4. The method of claim 1, wherein the payment account is associated with at least one of: (i) a consumer, (ii) a household, (iii) a business making purchases via the payment account, and (iv) a merchant receiving payments via the payment account.

5. The method of claim 1, wherein at least one of the payment codes is associated with a time category.

6. The method of claim 5, wherein at least one of the time category codes is associated with at least one of: (i) a weekday indication, (ii) a weekend indication, (iii) a school year indication, (iv) a business hours indication, (v) a holiday indication, (vi) an early morning indication, and (vii) a late night indication.

7. The method of claim 1, wherein at least one of the payment codes is associated with a geography category.

8. The method of claim 7, wherein at least one of the geography category codes is associated with at least one of: (i) a college town indication, (ii) an urban indication, (iii) a suburban indication, (iv) a rural indication, (v) a travel indication, (vi) an industrial indication, and (vii) a residential indication.

9. The method of claim 1, wherein at least one of the payment codes is associated with a spend category.

10. The method of claim 9, wherein at least one of the spend category codes is associated with at least one of: (i) an essential spend indication, (ii) a healthy spend indication, (iii) a sedentary spend indication, (iv) a high-end spend indication, and (v) a do-it-yourself spend indication.

11. The method of claim 1, wherein at least one of the payment codes is associated with a behavior category.

12. The method of claim 11, wherein at least one of the behavior category codes is associated with at least one of: (i) a repetitive purchase indication, (ii) a one-time purchase indication, (iii) a high-spend indication, and (iv) a purchase sequencing indication.

13. The method of claim 1, further comprising:
automatically identifying potential payment codes for the transaction database.

14. The method of claim 1, further comprising:
generating a confidence level associated with at least one payment code.

15. A non-transitory, computer-readable medium having stored therein instructions that, upon execution, cause a computer processor to perform a method, the method comprising:
retrieving, from a transaction database, transaction information associated with payments made via a payment account;
accessing a code book containing a plurality of payment codes and, for each payment code, logic defining when that payment code is applicable to a payment;
analyzing the retrieved transaction information to automatically determine which payment codes are associated with each payment; and
outputting the automatically determined coded transaction information.

16. The medium of claim 15, wherein the payment account is associated with at least one of: (i) a consumer, (ii) a household, (iii) a business making purchases via the payment account, and (iv) a merchant receiving payments via the payment account.

17. The medium of claim 15, wherein at least one of the payment codes is associated with at least one of: (i) a time category, (ii) a geography category, (iii) a spend category, and (iv) a behavior category.

18. An apparatus, comprising:
a transaction database storing transaction information associated with payments made via a payment account;
a code book storing a plurality of payment codes and, for each payment code, logic defining when that payment code is applicable to a payment; and
a classification platform coupled to the transaction database and code book to: (i) retrieving, from the transaction database, transaction information, (ii) analyze the retrieved transaction information to automatically determine which payment codes are associated with each payment, and (iii) output the automatically determined coded transaction information.

19. The apparatus of claim 18, wherein the payment account is associated with at least one of: (i) a consumer, (ii) a household, (iii) a business making purchases via the payment account, and (iv) a merchant receiving payments via the payment account.

20. The apparatus of claim 18, wherein at least one of the payment codes is associated with at least one of: (i) a time category, (ii) a geography category, (iii) a spend category, and (iv) a behavior category.
